(19) United States
(12) Patent Application Publication
(10) Pub. No.: US 2019/0273456 A1
(43) Pub. Date: Sep. 5, 2019

(54) STEPPING MOTOR CONTROL DEVICE, TIMEPIECE, AND CONTROL METHOD OF STEPPING MOTOR FOR TIMEPIECE

(71) Applicant: Seiko Instruments Inc., Chiba-shi (JP)

(72) Inventor: Akihito OKUMURA, Chiba-shi (JP)

(21) Appl. No.: 16/289,217

(22) Filed: Feb. 28, 2019

(30) Foreign Application Priority Data
Mar. 1, 2018 (JP) 2018-036940
Dec. 13, 2018 (JP) 2018-233332

(51) Int. Cl. H02P 8/02; G04C 3/14

(52) U.S. Cl. CPC H02P 8/02; G04C 3/143

(57) ABSTRACT

A stepping motor control device includes a rotation detection unit and a control unit. The rotation detection unit detects a rotation state of a rotor of the stepping motor after outputting a driving pulse to the stepping motor that rotates a hand. The control unit controls the hand to be driven to rotate in a reverse direction by outputting a plurality of first pulses having different energies as a plurality of test pulses before outputting the first pulse, causing the rotation detection unit to detect the rotation state of the rotor by the test pulse after outputting each of the plurality of test pulses, setting a test pulse according to the detected rotation state as the first pulse, and using the set first pulse and the second pulse having polarity different from that of the first pulse as the driving pulse.

### RELATED APPLICATIONS

This application claims priority under 35 U.S.C. § 119 to Japanese Patent Application Nos. 2018-036940 filed on Mar. 1, 2018 and 2018-233332 filed on Dec. 13, 2018, the entire contents of which are hereby incorporated by reference.

### BACKGROUND OF THE INVENTION

### 1. Field of the Invention

The present disclosure relates to a stepping motor control device, a timepiece, and a control method of a stepping motor for the timepiece.

### 2. Description of the Related Art

In a case of driving a stepping motor used for driving a hand of a timepiece by one coil, although there is an advantage, in the forward rotation drive, that consumption current can be lowered, it is necessary to temporarily rotate the stepping motor in a forward direction and to rotate the stepping motor by using one or more reverse rotation pulses with its reaction, in the reverse rotation drive. In the reverse rotation using such a reaction, since a rotor shakes rapidly in an opposite direction, stability of an operation tends to be affected by manufacturing variation and voltage. As a countermeasure against this, it is known to use a braking pulse after the reverse rotation, however, there is also a circumstance in which a total length of a pulse becomes longer due to the braking pulse. Since the total length of the pulse becomes longer such that a frequency at the time of reverse rotation is limited, a range of expression of the hand by hand movement can be limited.

In JP-A-55-59375, it is described that a first pulse length is changed according to a power supply voltage in the reverse rotation drive. In the technique described in JP-A-55-59375, countermeasures against factors other than voltage are not considered.

In JP-A-2014-117028, it is described that a reverse swinging pulse is pulled in an inverse direction before a first pulse to a third pulse of reverse-rotation driving pulses. In the technique described in JP-A-2014-117028, high-speed drive with high frequency can be limited.

In JP-A-2014-196986, it is described that a rank of a reverse rotation pulse after a forward rotation is determined by detecting a rotation state of the forward rotation. In the technique of a second embodiment of JP-A-2014-196986, when determining the reverse rotation pulse, it is necessary to rotate a rotor in the forward direction by one step in order to detect the rotation state of forward rotation in advance. Therefore, in the technique of the second embodiment of JP-A-2014-196986, it is not sufficient in terms of instantaneousness and responsiveness to instructions when starting the reverse rotation pulse.

### SUMMARY OF THE INVENTION

In view of the problems described above, embodiment of the invention provides a stepping motor control device, a timepiece, and a control method of a stepping motor for the timepiece capable of securing responsiveness when it is desired to make the stepping motor reverse rotation in reverse rotation control of the stepping motor.

A stepping motor control device according to an embodiment of the invention includes a rotation detection unit that detects a rotation state of a rotor of the stepping motor after outputting a driving pulse to the stepping motor that rotates a hand, a control unit that controls the hand to be driven to rotate in a reverse direction by at least a first pulse and a second pulse having polarity different from that of the first pulse as the driving pulse and controls the hand to be driven to rotate in the reverse direction by outputting a plurality of first pulses having different energies as a plurality of test pulses before outputting the first pulse, causing the rotation detection unit to detect the rotation state of the rotor by the test pulse after outputting each of the plurality of test pulses, setting a test pulse according to the detected rotation state as the first pulse, and using at least the set first pulse and the second pulse.

In the stepping motor control device according to the embodiment of the invention, the plurality of test pulses may be consecutively output in the order from a pulse having small energy to a pulse having large energy, and the control unit may set a test pulse having a predetermined energy less than energy necessary for forward rotation of the hand and corresponding to energy of a rotation pulse immediately before the rotor reaches a predetermined rotation angle as the first pulse.

In the stepping motor control device according to the embodiment of the invention, in a case where an induced voltage generated with application of the test pulse is larger than a reference threshold voltage, the control unit may determine that the rotor has the predetermined amount of energy and set the test pulse as the first pulse.

In the stepping motor control device according to the embodiment of the invention, in a case where a required time from an application time point of the test pulse to a time point at which the induced voltage larger than the reference threshold voltage is generated is equal to or longer than a determination period, the control unit may determine that the rotor has the predetermined amount of energy and set the test pulse as the first pulse.

The stepping motor control device according to the embodiment of the invention may further include a stator capable of forming a magnetic path with the rotor and a drive coil capable of forming a magnetic path in the stator, and in which the control unit may output the plurality of test pulses so that all of the plurality of test pulses are generated by one polarity of the magnetic path.

A timepiece according to the embodiment of the invention may include the stepping motor control device and the hand.

A control method of a stepping motor for a timepiece according to still embodiment of the invention includes a step of outputting a plurality of first pulses having different energies as a plurality of test pulses before outputting a first pulse as a driving pulse to a stepping motor that rotates a hand, a step of detecting the rotation state of the rotor by the test pulse after outputting each of the plurality of test pulses, a step of setting a test pulse according to the detected rotation state as the first pulse, and a step of driving the hand in a reverse direction by using at least the set first pulse and the second pulse having polarity different from that of the first pulse.

A control method of a stepping motor for a timepiece according to still embodiment of the invention includes, at the time of a reverse rotation start of the stepping motor, applying a first forward-rotation driving pulse having a pulse length to the extent that a stepping motor does not make a predetermined forward rotation to the stepping motor and determining whether or not the stepping motor has made the predetermined forward rotation by application of the first forward-rotation driving pulse, in a case where it is determined that the stepping motor has not made the predetermined forward rotation by the application of the first forward-rotation driving pulse, applying a second forward-rotation driving pulse obtained by adding pulse energy to the first forward-rotation driving pulse to the stepping motor and determining whether or not the stepping motor has made the predetermined forward rotation by application of the second forward-rotation driving pulse, in a case where it is determined that the stepping motor has made the predetermined forward rotation by the application of the second forward-rotation driving pulse, determining a pulse length of a reverse-rotation driving pulse based on a pulse length of the second forward-rotation driving pulse, and until the stepping motor makes the predetermined forward rotation, repeating addition of the pulse energy and a determination as to whether or not the stepping motor has made the predetermined forward rotation by application of the forward-rotation driving pulse after the addition.

In the control method of the stepping motor for the timepiece according to the embodiment of the invention, the application of the forward-rotation driving pulse may be repeated until the stepping motor makes the predetermined forward rotation, and application of a reverse-rotation driving pulse may not be performed until the stepping motor makes the predetermined forward rotation.

In the control method of the stepping motor for the timepiece according to the embodiment of the invention, in a case where an induced voltage generated with the application of the first forward-rotation driving pulse is larger than a reference threshold voltage, it may be determined that the stepping motor has made the predetermined forward rotation.

In the control method of the stepping motor for the timepiece according to the embodiment of the invention, in a case where the required time from an application time point of the first forward-rotation driving pulse to a time point at which the induced voltage larger than the reference threshold voltage is generated is equal to or longer than a determination period, it may be determined that the stepping motor has made the predetermined forward rotation.

In the stepping motor control device according to the embodiment of the invention, energy of a first test pulse of the plurality of test pulses that are consecutively output is energy of a driving pulse output to the stepping motor at the timing just before the first test pulse is output.

In the stepping motor control device according to the embodiment of the invention, polarity of at least one test pulse among the plurality of test pulses that are consecutively output is different from polarity of other test pulses.

In the stepping motor control device according to the embodiment of the invention, the time from application of the test pulse to application of the next test pulse is 15 ms or more.

In the stepping motor control device according to the embodiment of the invention, in a case where the energy of the test pulse is equal to or greater than a predetermined value and the induced voltage generated with the application of the test pulse is not larger than the reference threshold voltage, the first pulse, the second pulse, and a third pulse having predetermined energy and having the same polarity as that of the first pulse are applied to the stepping motor.

In the stepping motor control device according to the embodiment of the invention, in a case where a pulse length of the first pulse which is set by the control unit is a length within a predetermined range, the stepping motor is driven by the first pulse and the second pulse, and in a case where the pulse length of the first pulse which is set by the control unit is a length outside the predetermined range, the stepping motor is driven by the first pulse, the second pulse, and a third pulse having predetermined energy and having the same polarity as that of the first pulse.

### BRIEF DESCRIPTION OF THE DRAWINGS

FIG. 1 is a diagram illustrating an example of a schematic configuration of a timepiece according to a first embodiment.

FIG. 2 is a diagram illustrating an example of a configuration of a stepping motor illustrated in FIG. 1.

FIGS. 3A and 3B are views for explaining a general method of driving the stepping motor to rotate in a reverse direction.

FIG. 4 is a graph for explaining a problem of the example illustrated in FIG. 3A.

FIG. 5 is a flowchart for explaining an example of a process (reverse rotation preparation process) such as optimization of a length of a driving pulse P1 executed by the timepiece according to the first embodiment.

FIG. 6 is a time chart for explaining an example in which the process illustrated in FIG. 5 is executed by the timepiece according to the first embodiment.

FIG. 7 is a time chart for explaining another example in which the process illustrated in FIG. 5 is executed by the timepiece according to the first embodiment.

FIG. 8 is a flowchart for explaining an example of a process (reverse rotation preparation process) such as optimization of the length of the driving pulse P1 executed by a timepiece according to a second embodiment.

FIG. 9 is a time chart for explaining an example in which the process illustrated in FIG. 8 is executed by the timepiece according to the second embodiment.

FIG. 10 is a time chart for explaining another example in which the process illustrated in FIG. 8 is executed by the timepiece according to the second embodiment.

### DETAILED DESCRIPTION OF THE PREFERRED EMBODIMENTS

Hereinafter, embodiments of a stepping motor control device, a timepiece, and a control method of a stepping motor for the timepiece of the invention will be described with reference to the drawings.

### First Embodiment

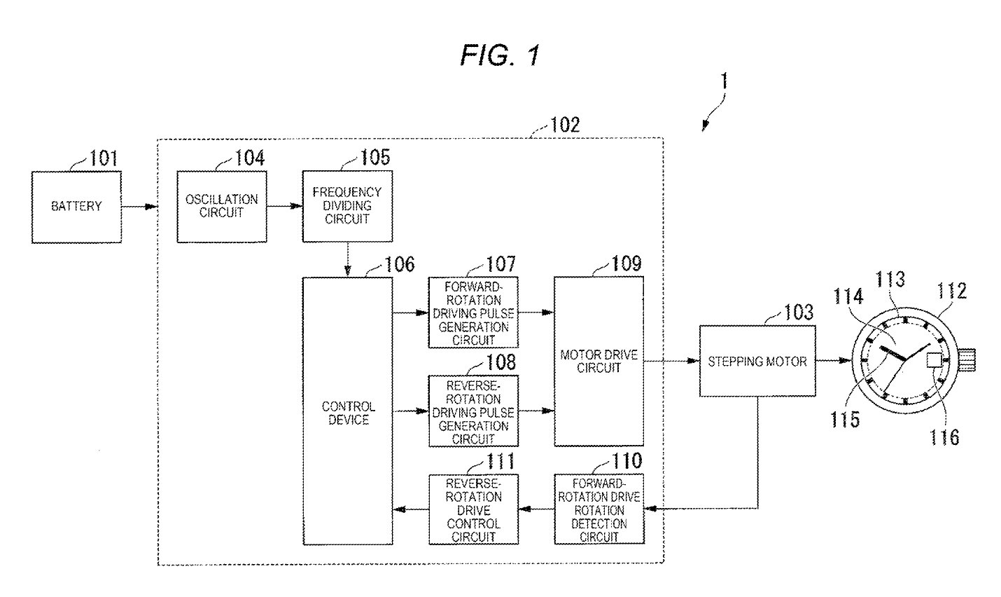

FIG. 1 is a diagram illustrating an example of a schematic configuration of a timepiece 1 according to a first embodiment.

In the example illustrated in FIG. 1, the timepiece 1 includes a battery 101, a stepping motor control device 102, a stepping motor 103, a timepiece case 112, an analog display portion 113, a movement 114, a hand 115, a calendar display portion 116.

The battery 101 supplies electric power to the stepping motor control device 102 and the like. The stepping motor control device 102 controls the stepping motor 103. The stepping motor control device 102 includes an oscillation circuit 104, a frequency dividing circuit 105, a control circuit 106, a forward-rotation driving pulse generation circuit 107, a reverse-rotation driving pulse generation circuit 108, a motor drive circuit 109, a forward-rotation drive rotation detection circuit 110, and a reverse-rotation drive control circuit 111.

The oscillation circuit 104 generates a signal of a predetermined frequency. The frequency dividing circuit 105 divides a frequency of the signal generated by the oscillation circuit 104 to generate a timepiece signal serving as a reference for time measurement. The control circuit 106 performs control of each electronic circuit element constituting an electronic timepiece, change control of a driving pulse, and the like, based on the timepiece signal and the like generated by the frequency dividing circuit 105.

The forward-rotation driving pulse generation circuit 107 generates a forward-rotation driving pulse for driving the stepping motor 103 to rotate in a forward direction, based on the control signal generated by the control circuit 106. Specifically, the forward-rotation driving pulse generating circuit 107 can generate a main driving pulse and an auxiliary driving pulse having a larger drive force than the main driving pulse based on the control signal generated by the control circuit 106.

The reverse-rotation driving pulse generation circuit 108 generates a reverse-rotation driving pulse for driving the stepping motor 103 to rotate in a reverse direction, based on control signal generated by the control circuit 106.

The motor drive circuit 109 drives the stepping motor 103 by applying the forward-rotation driving pulse generated by the forward-rotation driving pulse generation circuit 107 or the reverse-rotation driving pulse generated by the reverse-rotation driving pulse generation circuit 108.

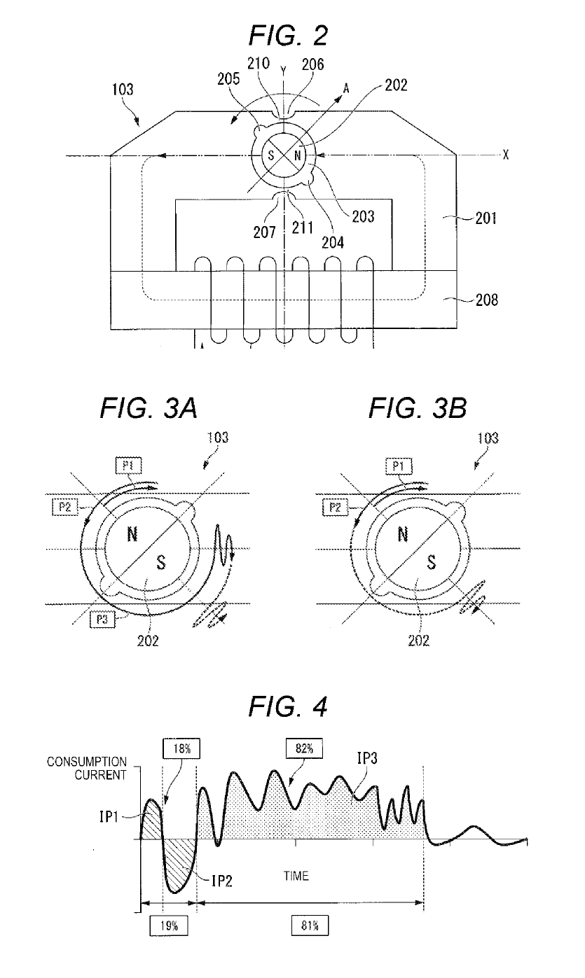

The forward-rotation drive rotation detection circuit 110 detects a rotation state of the stepping motor 103 by detecting an induced voltage VRs generated by free vibration of a rotor 202 (see FIG. 2) of the stepping motor 103 after the stepping motor 103 applies magnetic force by the driving pulse to the rotor 202. Specifically, in a case where the induced voltage VRs is larger than a reference threshold voltage Vcomp and in a case where the induced voltage VRs is equal to or less than the reference threshold voltage Vcomp, the forward-rotation drive rotation detection circuit 110 can determine the rotation state of the stepping motor 103 according to the time point at which these cases occur. Further, in a case where the induced voltage VRs is larger than the reference threshold voltage Vcomp, the forward-rotation drive rotation detection circuit 110 outputs a rotation detection signal Vs to the control circuit 106.

The reverse-rotation drive control circuit 111 outputs a reverse rotation drive control signal indicating a degree of a margin of reverse rotation drive to the control circuit 106.

FIG. 2 is a diagram illustrating an example of a configuration of the stepping motor 103 illustrated in FIG. 1.

In the example illustrated in FIG. 2, the stepping motor 103 includes a stator 201, the rotor 202, a rotor accommodating through-hole 203, cutout portions (inner notches) 204 and 205, cutout portions (outer notches) 206 and 207, a magnetic core 208, a drive coil 209, and saturable portions 210 and 211.

The stator 201 is formed of a magnetic material. In the stator 201, the rotor accommodating through-hole 203 for accommodating the rotor 202 is formed. The rotor accommodating through-hole 203 has the cutout portions (inner notches) 204 and 205.

The cutout portions 206 and 207 are formed in the stator 201. The saturable portion 210 is provided between the rotor accommodating through-hole 203 and the cutout portion 206. The saturable portion 211 is provided between the rotor accommodating through-hole 203 and the cutout portion 207.

The rotor 202 is magnetized in two poles (specifically, S-pole and N-pole). The rotor 202 is disposed in the rotor accommodating through-hole 203 so as to be rotatable with respect to the stator 201. The cutout portions 204 and 205 constitute a positioning portion for determining a stop position of the rotor 202 with respect to the stator 201.

The magnetic core 208 is joined to the stator 201. The magnetic core 208 and the stator 201 are fixed to a main plate (not illustrated). The drive coil 209 is wound around the magnetic core 208. A first terminal OUT1 is one terminal of the drive coil 209 and a second terminal OUT2 is the other terminal of the drive coil 209.

The saturable portions 210 and 211 are configured not to be magnetically saturated by a magnetic flux of the rotor 202 and to be magnetically saturated when the drive coil 209 is excited to increase a magnetic resistance. That is, a magnetic path can be formed between the stator 201 and the rotor 202. Further, the magnetic path can be formed in the stator 201 by the drive coil 209.

For example, in a state where the drive coil 209 is not excited, as illustrated in FIG. 2, the rotor 202 stably stops with respect to the stator 201 so that a line segment connecting the cutout portion 204 and the cutout portion 205 is orthogonal to a magnetic pole axis A of the rotor 202.

For example, in a case where the motor drive circuit 109 supplies a driving pulse between the first terminal OUT1 and the second terminal OUT2 of the drive coil 209 and a current i indicated by a solid arrow in FIG. 2 flows, the magnetic flux indicated by a broken line arrow in FIG. 2 is generated in the stator 201. With this configuration, the saturable portions 210 and 211 are saturated and the magnetic resistance is increased. Thereafter, due to the interaction between the magnetic poles generated in the stator 201 and the magnetic poles of the rotor 202, the rotor 202 rotates 180 degrees counterclockwise in FIG. 2 and stably stops. By this rotation of about 180 degrees, the hand 115 of the timepiece 1 can move by a specified amount of one scale. An operation of the specified amount may be referred to as one step in some cases. A train wheel having an appropriate speed reduction ratio is appropriately disposed between the rotor 202 and the hand 115 so as to achieve the operation of the specified amount.

In a state where the rotor 202 is rotated approximately 180 degrees from the state of FIG. 2, in a case where the motor drive circuit 109 supplies a driving pulse of opposite polarity between the first terminal OUT1 and the second terminal OUT2 of the drive coil 209 and a current in the direction opposite to the current i flows, a magnetic flux in a direction opposite to the direction indicated by the broken line arrow is generated in the stator 201. With this configuration, the saturable portions 210 and 211 are saturated first, and then the rotor 202 rotates 180 degrees counterclockwise in FIG. 2 due to the interaction between the magnetic poles generated in the stator 201 and the magnetic poles of the rotor 202 and stably stops.

In this way, by supplying signals (alternating signals) of different polarities to the drive coil 209, the rotor 202 consecutively rotates by approximately 180 degrees counterclockwise in FIG. 2.

Returning to the description of FIG. 1, the timepiece case 112 accommodates the battery 101, the stepping motor control device 102, the stepping motor 103, the analog display portion 113, the movement 114, the hand 115, and the calendar display portion 116. The movement 114 is a mechanical body including a drive part of the timepiece 1. The hand 115 and the calendar display portion 116 are driven by the stepping motor 103. The analog display hand 113 and the hand 115 display the time.

FIGS. 3A and 3B are views for explaining a general method of driving the stepping motor 103 to rotate in a reverse direction. Specifically, FIG. 3A illustrates an example of a general method of rotating the stepping motor 103 in the reverse direction by applying three driving pulses. FIG. 3B illustrates an example of a general method of rotating the stepping motor 103 in the reverse direction by applying two driving pulses.

In the example illustrated in FIG. 3A, first, a driving pulse (repulsion pulse) P1 for rotating the rotor 202 of the stepping motor 103 in the forward rotation direction is applied to the stepping motor 103. Next, the driving pulse (suction pulse) P2 for rotating the rotor 202 of the stepping motor 103 in the reverse direction is applied to the stepping motor 103. Next, a driving pulse P3 is applied to the stepping motor 103. As a result, the rotor 202 of the stepping motor 103 is rotated in the reverse direction.

That is, in the example illustrated in FIG. 3A, the rotor 202 of the stepping motor 103 is temporarily rotated in the forward rotation direction by the driving pulse P1. Next, the rotor 202 is rotated in the reverse direction by the driving pulse P2 and the driving pulse P3 by using reaction of the rotation in the forward rotation direction.

In the example illustrated in FIG. 3B, first, the driving pulse (repulsion pulse) P1 for rotating the rotor 202 of the stepping motor 103 in the forward direction is applied to the stepping motor 103. Next, the driving pulse (suction pulse) P2 for rotating the rotor 202 of the stepping motor 103 in the reverse direction is applied to the stepping motor 103. As a result, the rotor 202 of the stepping motor 103 is rotated in the reverse direction.

That is, in the example illustrated in FIG. 3B, the rotor 202 of the stepping motor 103 is temporarily rotated in the forward rotation direction by the driving pulse P1. Next, the rotor 202 is rotated in the reverse direction by the driving pulse P2 by using the reaction of the rotation in the forward rotation direction.

As illustrated in FIG. 3B, reverse rotation of the rotor 202 of the stepping motor 103 is established even with only two driving pulses of the repulsion pulse P1 and the suction pulse P2. Meanwhile, as a countermeasure for step-out of the stepping motor 103 due to manufacturing variation and a magnetic field, it is common to add the driving pulse P3 as illustrated in FIG. 3A. The driving pulse P3 acts as a repulsion pulse to a suction pulse.

Such a set of the driving pulses P1, P2, and P3 will be referred to as a reverse rotation pulse or a reverse-rotation driving pulse in the following. Further, the reverse rotation pulse or the reverse-rotation driving pulse can be constituted by only the driving pulses P1 and P2.

FIG. 4 is a graph for explaining a problem of the example illustrated in FIG. 3A.

In FIG. 4, the vertical axis represents a consumption current of the stepping motor 103. The horizontal axis represents the time. The “IP1” indicates an instantaneous value of a consumption current of the stepping motor 103 with application of the driving pulse P1. The “IP2” indicates the instantaneous value of the consumption current of the stepping motor 103 with application of the driving pulse P2. The “IP3” indicates the instantaneous value of the consumption current of the stepping motor 103 with application of the driving pulse P3.

In the example illustrated in FIG. 4, the consumption current (integral value) of the stepping motor 103 with the application of the driving pulse P1 and the driving pulse P2 accounts for 18% of the total consumption current. The consumption current (integral value) of the stepping motor 103 with the application of the driving pulse P3 accounts for 82% of the total consumption current.

The rotation required time of the rotor 202 of the stepping motor 103 with the application of the driving pulse P1 and the driving pulse P2 accounts for 19% of the total rotation required time. The rotation required time of the rotor 202 of the stepping motor 103 with the application of the driving pulse P3 accounts for 81% of the total rotation required time.

As illustrated in FIG. 4, in a case where the driving pulse P3 is applied, the total rotation required time of the rotor 202 of the stepping motor 103 becomes longer. That is, it may be difficult to speed up the rotation of the rotor 202 of the stepping motor 103 in the reverse direction.

Further, in a case where the driving pulse P3 is applied, the total consumption current of the stepping motor 103 increases. That is, it may be difficult to reduce power consumption for rotating the rotor 202 of the stepping motor 103 in the reverse direction.

In view of the problem described above, in the timepiece 1 of the first embodiment, the application of the driving pulse P3 (see FIG. 3A) is not performed. Further, in the timepiece 1 of the first embodiment, optimization of a length of the driving pulse P1 is performed.

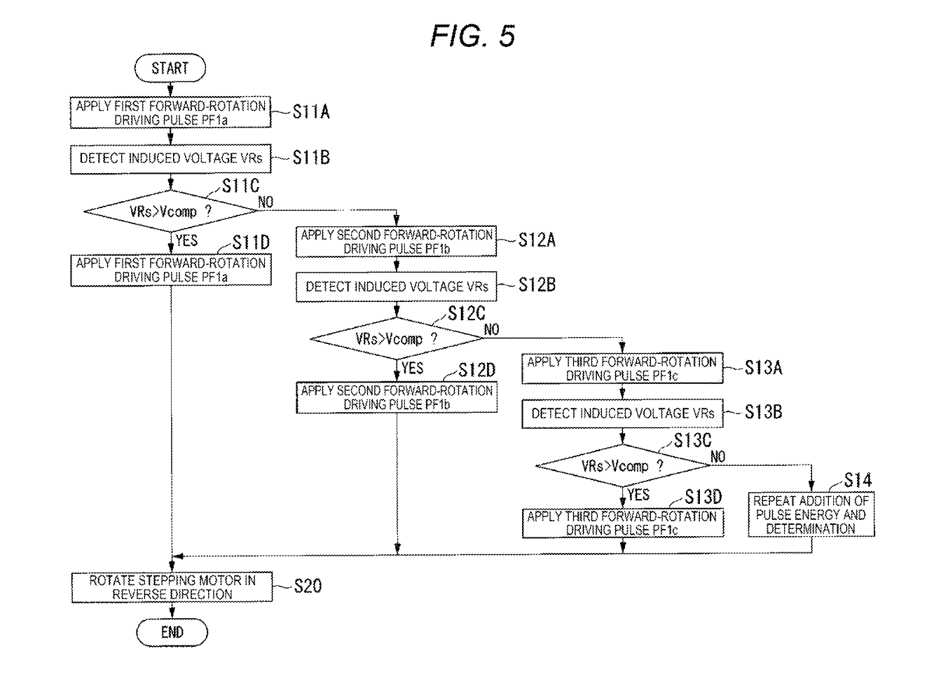

FIG. 5 is a flowchart for explaining an example of a process (reverse rotation preparation process) such as optimization of the length of the driving pulse P1 executed by the timepiece 1 according to the first embodiment.

In the example illustrated in FIG. 5, when the timepiece 1 of the first embodiment starts the reverse rotation preparation process (that is, at the time of the reverse rotation start of the stepping motor 103), first, in step S11A, the motor drive circuit 109 applies a first forward-rotation driving pulse PF1a having a pulse length that does not cause the stepping motor 103 to perform predetermined forward rotation (forward rotation less than 180 degrees rotation) to the stepping motor 103.

Here, a relationship between predetermined forward rotation and forward rotation will be described. The predetermined forward rotation means a rotation state to the extent that the direction of the magnetic pole of the rotor (solid arrow A in FIG. 2) does not barely exceed the position of the cutout portion 205 (cutout portion 204 in the case of a driving pulse of opposite polarity). If the magnetic pole of the rotor exceeds the cutout portion 205, the rotor rotates to exceed a position at which magnetic potential energy becomes the maximum, and the rotor can rotate to approximately 180 degrees. Such rotation exceeding the potential energy maximum point is referred to as the forward rotation. With this configuration, the rotor can be rotated by approximately 180 degrees, and the hand can move one step. If the magnetic pole of the rotor cannot exceed the cutout portion 205, the magnetic pole of the rotor cannot exceed the potential energy maximum point and tries to return to the 0° position which is the start position before application of the driving pulse.

Next, in step S11B, the forward-rotation drive rotation detection circuit 110 detects the induced voltage VRs.

Next, in step S11C, the forward-rotation drive rotation detection circuit 110 determines whether or not the induced voltage VRs is larger than the reference threshold voltage Vcomp.

In a case where the induced voltage VRs is larger than the reference threshold voltage Vcomp, it is determined that the stepping motor 103 has made a predetermined forward rotation by application of the first forward-rotation driving pulse PF1a, and the process proceeds to step S11D. As described above, the pulse length of the first forward-rotation driving pulse PF1a is set to a pulse length to the extent that the stepping motor 103 does not make the predetermined forward rotation. Therefore, when the induced voltage VRs is larger than the reference threshold voltage Vcomp in step S11C, the forward-rotation drive rotation detection circuit 110 does not make a determination.

In a case where the induced voltage VRs is equal to or lower than the reference threshold voltage Vcomp, it is determined that the stepping motor 103 has not made the predetermined forward rotation by the application of the first forward-rotation driving pulse PF1a, and the process proceeds to step S12A.

In step S11D, the motor drive circuit 109 applies the first forward-rotation driving pulse PF1a to the stepping motor 103 as the driving pulse (repulsion pulse) P1 described above. Next, the process proceeds to step S20.

In step S12A, the motor drive circuit 109 applies a second forward-rotation driving pulse PFlb obtained by adding pulse energy to the first forward-rotation driving pulse PF1a to the stepping motor 103. This control may also be referred to as rank-up.

Next, in step S12B, the forward-rotation drive rotation detection circuit 110 detects the induced voltage VRs.

Next, in step S12C, the forward-rotation drive rotation detection circuit 110 determines whether or not the induced voltage VRs is larger than the reference threshold voltage Vcomp.

In a case where the induced voltage VRs is larger than the reference threshold voltage Vcomp, it is determined that the stepping motor 103 has made a predetermined forward rotation by application of the second forward-rotation driving pulse PF1b, and the process proceeds to step S12D.

In a case where the induced voltage VRs is equal to or lower than the reference threshold voltage Vcomp, it is determined that the stepping motor 103 has not made the predetermined forward rotation by the application of the second forward-rotation driving pulse PF1b, and the process proceeds to step S13A.

In step S12D, the motor drive circuit 109 applies the second forward-rotation driving pulse PFlb to the stepping motor 103 as the driving pulse (repulsion pulse) P1 described above. Next, the process proceeds to step S20.

In step S13A, the motor drive circuit 109 applies a third forward-rotation driving pulse PF1c obtained by adding pulse energy to the second forward-rotation driving pulse PFlb to the stepping motor 103 (rank-up).

Next, in step S13B, the forward-rotation drive rotation detection circuit 110 detects the induced voltage VRs.

Next, in step S13C, the forward-rotation drive rotation detection circuit 110 determines whether or not the induced voltage VRs is larger than the reference threshold voltage Vcomp.

In a case where the induced voltage VRs is larger than the reference threshold voltage Vcomp, it is determined that the stepping motor 103 has made a predetermined forward rotation by application of the third forward-rotation driving pulse PF1c, and the process proceeds to step S13D.

In a case where the induced voltage VRs is equal to or lower than the reference threshold voltage Vcomp, it is determined that the stepping motor 103 has not made the predetermined forward rotation by the application of the third forward-rotation driving pulse PF1c, and the process proceeds to step S14.

In step S13D, the motor drive circuit 109 applies the third forward-rotation driving pulse PF to the stepping motor 103 as the driving pulse (repulsion pulse) P1 described above. Next, the process proceeds to step S20.

In step S14, addition of pulse energy and the determination of whether or not the stepping motor 103 has made the predetermined forward rotation by the application of the forward-rotation driving pulse after the addition of the pulse energy are repeated until the induced voltage VRs becomes larger than the reference threshold voltage Vcomp, and the forward-rotation driving pulse when the induced voltage VRs becomes larger than the reference threshold voltage Vcomp is applied to the stepping motor 103 as the driving pulse (repulsion pulse) P1 described above.

In the step S20, a pulse length of a reverse-rotation driving pulse is determined based on the pulse length of the driving pulse when the induced voltage VRs becomes larger than the reference threshold voltage Vcomp.

Specifically, in a case where it is determined that the induced voltage VRs is larger than the reference threshold voltage Vcomp in step S12C, the pulse length of the reverse-rotation driving pulse is determined based on the pulse length of the second forward-rotation driving pulse PF1b.

For example, in a case where it is determined in step S13C that the induced voltage VRs is larger than the reference threshold voltage Vcomp, the pulse length of the reverse-rotation driving pulse is determined based on the pulse length of the third forward-rotation driving pulse PF1c. The pulse length determined here corresponds to a predetermined amount of energy less than the energy required to rotate the hand in the forward direction.

In step S20, the motor drive circuit 109 applies the reverse-rotation driving pulse as the driving pulse (suction pulse) P2 described above to the stepping motor 103. As a result, as illustrated in FIG. 3B, the rotor 202 of the stepping motor 103 is rotated in the reverse direction.

Specifically, in the example illustrated in FIG. 5, for example, in a case where it is determined that the induced voltage VRs is larger than the reference threshold voltage Vcomp in step S13C, it is determined that the stepping motor 103 has rotated by a predetermined amount in the forward rotation direction by pulse energy in step S13A and the stepping motor 103 is driven in the forward rotation direction in step S13D by energy equivalent to the pulse energy. The predetermined amount refers to a condition to the extent that the direction (solid arrow A in FIG. 2) of the magnetic pole of the rotor does not barely exceed the position of the cutout portion 205 (cutout portion 204 in the case of driving pulse of opposite polarity). The predetermined amount is an amount of rotation caused by energy corresponding to the predetermined forward rotation described above or an amount of rotation when the rotor is rotated by the driving pulse having the energy.

At least the driving pulse P2 is set in step S20 with energy of the pulse as the driving pulse P1, and the reverse rotation pulse is set by a combination of these driving pulses, and the stepping motor 103 is rotated in the reverse direction.

According to the example illustrated in FIG. 5, the stepping motor 103 can be rotated in the reverse direction by using the forward-rotation driving pulse having the pulse length with which the stepping motor 103 rotates in a predetermined forward direction. As a result, high-speed reverse rotation of the stepping motor 103 and reduction in power consumption can be realized.

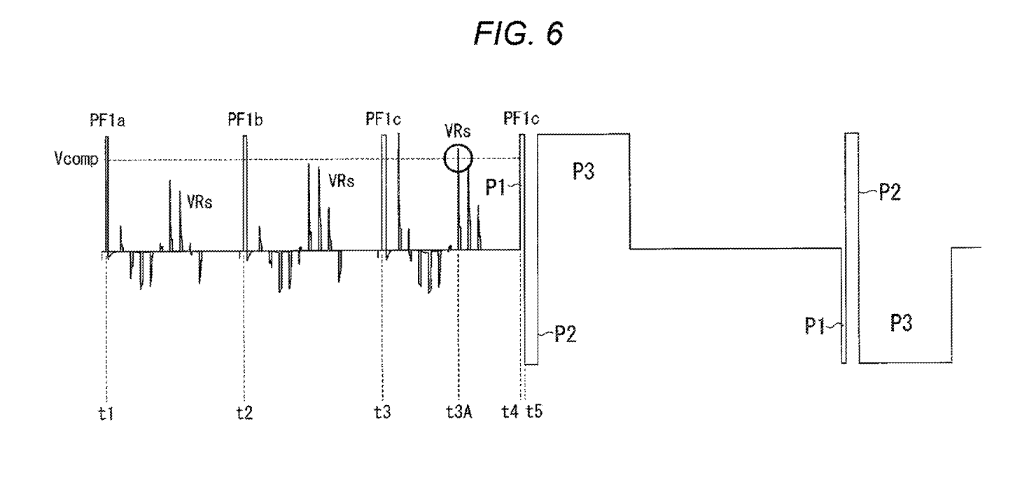

FIG. 6 is a time chart for explaining an example in which the process illustrated in FIG. 5 is executed by the timepiece 1 according to the first embodiment.

In the example illustrated in FIG. 6, at time t1, the step S11A in FIG. 5 is executed, and the motor drive circuit 109 applies the first forward-rotation driving pulse PF1a to the stepping motor 103.

Next, steps S11B and S11C in FIG. 5 are executed before time t2, and it is determined that the induced voltage VRs is equal to or lower than the reference threshold voltage Vcomp and the stepping motor 103 has not made the predetermined forward rotation by the application of the first forward-rotation driving pulse PF1a.

Next, at time t2, the step S12A in FIG. 5 is executed, and the motor drive circuit 109 applies the second forward-rotation driving pulse PF1b to the stepping motor 103.

Next, the steps S12B and S12C in FIG. 5 are executed before time t3, and it is determined that the induced voltage VRs is equal to or lower than the reference threshold voltage Vcomp and the stepping motor 103 has not made the predetermined forward rotation by the application of the second forward-rotation driving pulse PF1b.

Next, at time t3, the step S13A in FIG. 5 is executed, and the motor drive circuit 109 applies the third forward-rotation driving pulse PF to the stepping motor 103.

Next, at time t3A, the step S13B and step S13C in FIG. 5 are executed, and it is determined that the induced voltage VRs is larger than the reference threshold voltage Vcomp and the stepping motor 103 has made the predetermined forward rotation by the application of the third forward-rotation driving pulse PF1c.

Next, at time t4, the step S13D of FIG. 5 is executed and the motor drive circuit 109 applies the third forward-rotation driving pulse PF to the stepping motor 103 as the driving pulse (repulsion pulse) P1 (see FIG. 3B).

Next, at or after time t5, step S20 of FIG. 5 is executed, and the reverse driving pulse whose pulse length is determined based on the pulse length of the third forward-rotation driving pulse PF1c is applied to the stepping motor 103 as the driving pulses (suction pulses) P2 and P3 by the motor drive circuit 109. As a result, the stepping motor 103 is rotated in the reverse direction.

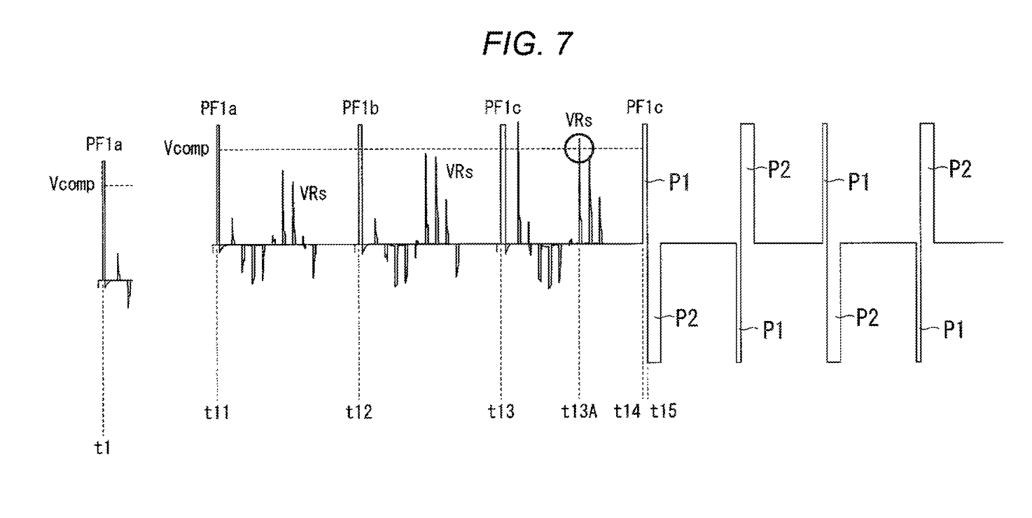

FIG. 7 is a time chart for explaining another example in which the process illustrated in FIG. 5 is executed by the timepiece 1 according to the first embodiment.

In the example illustrated in FIG. 7, at time t11, the step S11A in FIG. 5 is executed and the motor drive circuit 109 applies the first forward-rotation driving pulse PF1a to the stepping motor 103.

Next, the steps S11B and S11C in FIG. 5 are executed before time t12, and it is determined that the induced voltage VRs is equal to or lower than the reference threshold voltage Vcomp and the stepping motor 103 has not made the predetermined forward rotation by the application of the first forward-rotation driving pulse PF1a.

Next, at time t12, the step S12A in FIG. 5 is executed, and the motor drive circuit 109 applies the second forward-rotation driving pulse PFlb to the stepping motor 103.

Next, the steps S12B and S12C in FIG. 5 are executed before time t13, and it is determined that the induced voltage VRs is equal to or lower than the reference threshold voltage Vcomp and the stepping motor 103 has not made the predetermined forward rotation by the application of the second forward-rotation driving pulse PF1b.

Next, at time t13, the step S13A in FIG. 5 is executed, and the motor drive circuit 109 applies the third forward-rotation driving pulse PF1c to the stepping motor 103.

Next, at time t13A, the step S13B and step S13C in FIG. 5 are executed, and it is determined that the induced voltage VRs is larger than the reference threshold voltage Vcomp and the stepping motor 103 has made the predetermined forward rotation by the application of the third forward-rotation driving pulse PF1c.

Next, at time t14, the step S13D in FIG. 5 is executed and the motor drive circuit 109 applies the third forward-rotation driving pulse PF1c to the stepping motor 103 as the driving pulse (repulsion pulse) P1 (see FIG. 3B).

Next, at or after time t15, step S20 in FIG. 5 is executed, and the reverse driving pulse whose pulse length is determined based on the pulse length of the third forward-rotation driving pulse PF1c is applied to the stepping motor 103 as the driving pulse (suction pulse) P2 by the motor drive circuit 109. As a result, the stepping motor 103 is rotated in the reverse direction.

The difference between the example illustrated in FIG. 6 and the example illustrated in FIG. 7 is the presence or absence of the driving pulse P3. In the invention, the driving pulse P3 is unnecessary, and the reverse rotation by only the driving pulses P1 and P2 can also be made. With this configuration, the pulse length necessary for the reverse rotation can be shortened, so that it is possible to further increase the drive frequency of reverse rotation.

### Summary of First Embodiment

As described above, in the timepiece 1 of the first embodiment, the driving pulses PF1a, PF1b, PF1c, and the like to the stepping motor 103 for rotating the hand 115 are output, for example, in steps S11A, S12A, S13A and the like in FIG. 5. After the output of the driving pulses PF1a, PF1b, PF and the like, the rotation state of the rotor 202 of the stepping motor 103 is detected in steps S11B, S12B, S13B and the like.

In the example illustrated in FIGS. 5 and 6, for example, before the third forward driving pulse PF1c is output as the driving pulse (repulsion pulse) P1 (see FIG. 3B) in the step S13d, the plurality of forward-rotation driving pulses PF1a, PF1b, and PF having different energies are output as a plurality of test pulses in the steps S11A, S12A, and S13A.

After the test pulse PF1a is output, the state of rotation of the rotor 202 by the test pulse PF1a is detected in step S11B. After the test pulse PF1b is output, the rotation state of the rotor 202 by the test pulse PF1b is detected in step S12B. After the test pulse PF1c is output, the rotation state of the rotor 202 by the test pulse PF1c is detected in step S13B.

When the rotation of the rotor 202 by the test pulse PF1c is detected in the step S13B and the step S13C, the test pulse PF with which the rotor 202 is rotated in the predetermined forward rotation is set as the forward-rotation driving pulse PF and the forward-rotation driving pulse PF is output as the driving pulse (repulsion pulse) P1 in step S13D.

In step S20, reverse-rotation driving pulses having different polarities from the forward-rotation driving pulse PF are output as the driving pulses (suction pulses) P2 (see FIGS. 6 and 7) and P3 (see FIG. 6).

That is, in the examples illustrated in FIGS. 5, 6, and 7, the hand 115 is driven to rotate in the reverse direction by the forward-rotation driving pulse PF output in the step S13D and the reverse-rotation driving pulse output in the step S20.

Therefore, according to the timepiece 1 of the first embodiment, in reverse rotation control of the stepping motor 103, it is possible to secure responsiveness when it is desired to rotate in the reverse direction by energy corresponding to the rotation state. Specifically, in selecting optimum energy of the driving pulse necessary for reverse rotation, it is possible to select optimum energy without rotating the rotor 202. Accordingly, responsiveness at the start of reverse rotation can be secured.

For example, in the examples illustrated in FIGS. 5, 6 and 7, the plurality of test pulses PF1a, PF1b, and PF are consecutively output in the order from the pulse PF1a having small energy to a pulse PF having large energy. The test pulse PF having energy less than energy necessary for forward rotation of the hand 115 and corresponding to energy of the rotation pulse immediately before the rotor 202 reaches the rotation angle corresponding to the specified amount is set as the forward-rotation driving pulse PF and is output in the step S13D.

Specifically, in a case where the induced voltage VRs generated with application of the test pulse PF1c is larger than the reference threshold voltage Vcomp, it is determined that the rotor 202 has energy which corresponds to energy of the rotation pulse immediately before the rotor 202 reaches the rotation angle corresponding to the specified amount and the test pulse PF is set as the forward-rotation driving pulse PF1c.

Therefore, according to the timepiece 1 of the first embodiment, it is possible to suppress the possibility that a pulse having energy (that is, energy larger than necessary) larger than the test pulse PF1c is set as the forward-rotation driving pulse and output.

For example, in the example illustrated in FIG. 6, the control circuit 106 outputs the plurality of test pulses PF1a, PF1b, and PF such that all of the plurality of test pulses PF1a, PF1b, and PF are generated by one polarity (specifically, polarity on the upper side in FIG. 6) of the magnetic path.

For example, in the example illustrated in FIG. 6, before time t3A at which it is detected that the minimum energy is required for the stepping motor 103 to constitute the reverse rotation pulse, application of the test pulse such as the forward-rotation driving pulses PF1a, PF1b, and is repeated. Specifically, the forward-rotation driving pulse PF1a is applied at time t1, the forward-rotation driving pulse PF1b is applied at time t2, and the forward-rotation driving pulse PF is applied at time t3. Note that this is only an example, and application of the number of these test pulses is continued until time t3A such as the time at which an induced voltage is detected.

The application of the reverse-rotation driving pulse is not performed before time t3A at which the stepping motor 103 makes a predetermined forward rotation. The application of the reverse-rotation driving pulse is performed at time t4.

Therefore, according to the timepiece 1 of the first embodiment, it is possible to suppress the possibility that the reverse-rotation driving pulse is wastefully applied before the time t3 at which reaction of rotation in the forward rotation direction is insufficient.

### Second Embodiment

Hereinafter, a second embodiment of the stepping motor control device, the timepiece, and the stepping motor control method of the invention will be described with reference to the drawings.

The timepiece 1 of the second embodiment is configured similarly to the timepiece 1 of the first embodiment described above except for the points to be described later. Accordingly, according to the timepiece 1 of the second embodiment, the same effects as those of the timepiece 1 of the first embodiment described above can be exhibited except for the points to be described later.

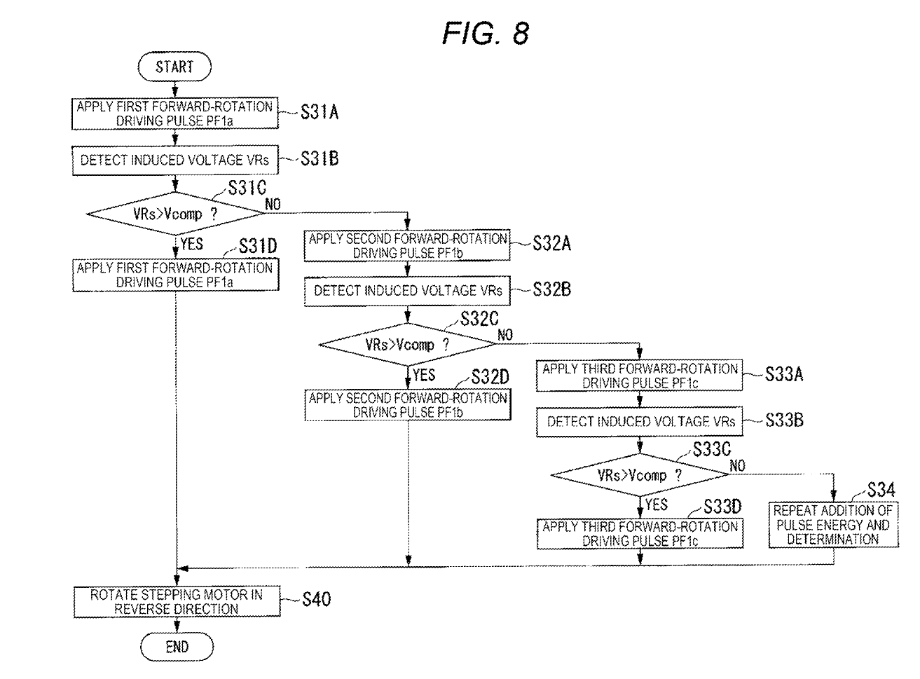

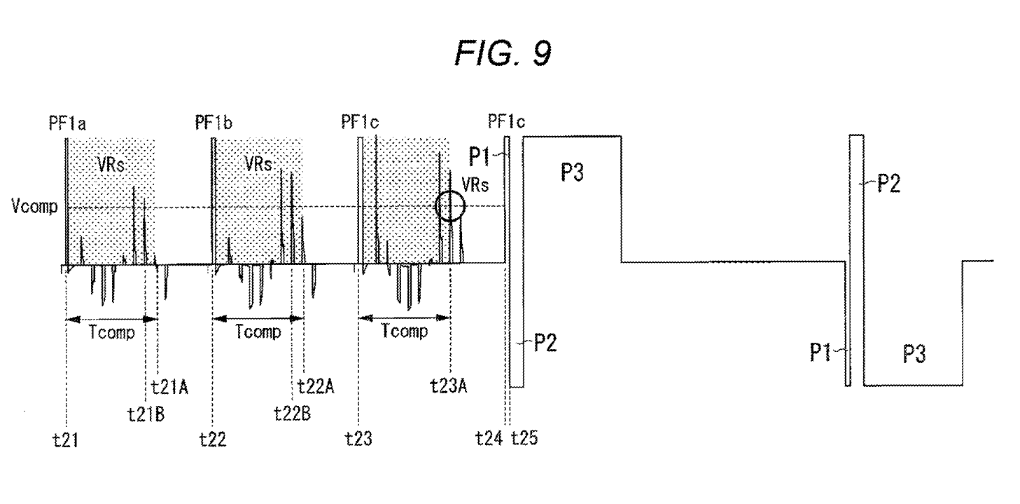

FIG. 8 is a flowchart for explaining an example of a process (reverse preparation process) such as optimization of the length of the driving pulse P1 executed by the timepiece 1 of the second embodiment.

In the example illustrated in FIG. 8, when the timepiece 1 of the second embodiment starts the reverse rotation preparation process (that is, at the time of the reverse rotation start of the stepping motor 103), first, in step S31A, the motor drive circuit 109 applies the first forward-rotation driving pulse PF1a having a pulse length that does not cause the stepping motor 103 to perform predetermined forward rotation to the stepping motor 103.

Next, in step S31B, the forward-rotation drive rotation detection circuit 110 detects the induced voltage VRs at or after the time point after the lapse of a first determination period, which is the time point at which a determination period Tcomp elapses from the application time point of the first forward-rotation driving pulse PF1a.

Next, in step S31C, the forward-rotation drive rotation detection circuit 110 determines whether or not the induced voltage VRs becomes larger than the reference threshold voltage Vcomp at or after the time point after the lapse of the first determination period.

In a case where the induced voltage VRs becomes larger than the reference threshold voltage Vcomp at or after the time point after the lapse of the first determination period, it is determined that the stepping motor 103 has made the predetermined forward rotation by the application of the first forward-rotation driving pulse PF1a, and the process proceeds to step S31D. As described above, the pulse length of the first forward-rotation driving pulse PF1a is set to a pulse length which is such a degree that the stepping motor 103 does not make the predetermined forward rotation. Therefore, in the step S31C, when the induced voltage VRs becomes larger than the reference threshold voltage Vcomp at or after the time point after the lapse of the first determination period, the forward-rotation drive rotation detection circuit 110 does not make a determination.

In a case where the induced voltage VRs does not become larger than the reference threshold voltage Vcomp at or after the time point after the lapse of the first determination period, it is determined that the stepping motor 103 has not made the predetermined forward rotation by the application of the first forward-rotation driving pulse PF1a and the process proceeds to step S32A.

In step S31D, the motor drive circuit 109 applies the first forward-rotation driving pulse PF1a to the stepping motor 103 as the driving pulse (repulsion pulse) P1 described above. Next, the process proceeds to step S40.

In step S32A, the motor drive circuit 109 applies the second forward-rotation driving pulse PF1b obtained by adding pulse energy to the first forward-rotation driving pulse PF1a to the stepping motor 103.

Next, in step S32B, the forward-rotation drive rotation detection circuit 110 detects the induced voltage VRs at or after the time point after the lapse of a second determination period, which is the time point at which the determination period Tcomp elapses from the application time point of the second forward-rotation driving pulse PF1b.

Next, in step S32C, the forward-rotation drive rotation detection circuit 110 determines whether or not the induced voltage VRs becomes larger than the reference threshold voltage Vcomp at or after the time point after the lapse of the second determination period.

In a case where the induced voltage VRs becomes larger than the reference threshold voltage Vcomp at or after the time point after the lapse of the second determination period, it is determined that the stepping motor 103 has made the predetermined forward rotation by the application of the second forward-rotation driving pulse PF1b, and the process proceeds to step S32D.

In a case where the induced voltage VRs does not become larger than the reference threshold voltage Vcomp at or after the time point after the lapse of the second determination period, it is determined that the stepping motor 103 has not made the predetermined forward rotation by the application of the second forward-rotation driving pulse PF1b and the process proceeds to step S33A.

In step S32D, the motor drive circuit 109 applies the second forward-rotation driving pulse PFlb to the stepping motor 103 as the driving pulse (repulsion pulse) P1 described above. Next, the process proceeds to the step S40.

In step S33A, the motor drive circuit 109 applies the third forward-rotation driving pulse PF obtained by adding pulse energy to the second forward-rotation driving pulse PF1b to the stepping motor 103.

Next, in step S33B, the forward-rotation drive rotation detection circuit 110 detects the induced voltage VRs at or after the time point after the lapse of a third determination period, which is the time point at which the determination period Tcomp elapses from the application time point of the third forward-rotation driving pulse PF1c.

Next, in step S33C, the forward-rotation drive rotation detection circuit 110 determines whether or not the induced voltage VRs becomes larger than the reference threshold voltage Vcomp at or after the time point after the lapse of the third determination period.

In a case where the induced voltage VRs becomes larger than the reference threshold voltage Vcomp at or after the time point after the lapse of the third determination period, it is determined that the stepping motor 103 has made the predetermined forward rotation by the application of the third forward-rotation driving pulse PF1c, and the process proceeds to step S33D.

In a case where the induced voltage VRs does not become larger than the reference threshold voltage Vcomp at or after the time point after the lapse of the third determination period, it is determined that the stepping motor 103 has not made the predetermined forward rotation by the application of the third forward-rotation driving pulse PF1c and the process proceeds to step S34.

In step S33D, the motor drive circuit 109 applies the third forward-rotation driving pulse PF to the stepping motor 103 as the driving pulse (repulsion pulse) P1 described above. Next, the process proceeds to the step S40.

In step S34, at or after the time point at which the determination period Tcomp elapses from the application time point of the forward-rotation driving pulse, addition of pulse energy and the determination of whether or not the stepping motor 103 has made the predetermined forward rotation by the application of the forward-rotation driving pulse after the addition of the pulse energy are repeated until the induced voltage VRs becomes larger than the reference threshold voltage Vcomp, and the forward-rotation driving pulse when the induced voltage VRs becomes larger than the reference threshold voltage Vcomp is applied to the stepping motor 103 as the driving pulse (repulsion pulse) P1 described above.

In step S40, a pulse length of a reverse-rotation driving pulse is determined based on the pulse length of the driving pulse when the induced voltage VRs becomes larger than the reference threshold voltage Vcomp.

Specifically, in a case where it is determined that the induced voltage VRs is larger than the reference threshold voltage Vcomp in the step S32C, the pulse length of the reverse-rotation driving pulse is determined based on the pulse length of the second forward-rotation driving pulse PF1b.

For example, in a case where it is determined in the step S33C that the induced voltage VRs is larger than the reference threshold voltage Vcomp, the pulse length of the reverse-rotation driving pulse is determined based on the pulse length of the third forward-rotation driving pulse PF1c.

In step S40, the motor drive circuit 109 applies the reverse-rotation driving pulse as the driving pulse (suction pulse) P2 described above to the stepping motor 103. As a result, as illustrated in FIG. 3B, the rotor 202 of the stepping motor 103 is rotated in the reverse direction.

Specifically, in the example illustrated in FIG. 8, for example, in a case where it is determined that the induced voltage VRs is larger than the reference threshold voltage Vcomp in the step S33C, it is determined that the stepping motor 103 has made a predetermined forward rotation by pulse energy in the step S33A and the stepping motor 103 is driven in the forward rotation direction in the step S33D by energy equivalent to the pulse energy. The predetermined forward rotation means a state to the extent that the direction of the magnetic pole of the rotor (solid arrow A in FIG. 2) does not barely exceed the position of the cutout portion 205 (cutout portion 204 in the case of a driving pulse of opposite polarity), similarly as in the first embodiment. If the magnetic pole of the rotor exceeds the cutout portion 205, the rotor rotates to exceed a position at which magnetic potential energy becomes the maximum, and the rotor can rotate as it is to approximately 180 degrees.

At least the driving pulse P2 is set in the step S40 with energy of the pulse as the driving pulse P1, and the reverse rotation pulse is set by a combination of these driving pulses, and the stepping motor 103 is rotated in the reverse direction.

In the example illustrated in FIG. 8, in a case where the required time from the application time point of the test pulse to the time point at which the induced voltage VRs larger than the reference threshold voltage Vcomp is generated is equal to or longer than the determination period Tcomp, it is determined that the rotor 202 has the amount of energy corresponding to a predetermined forward rotation and the test pulse is set as the driving pulse P1.

According to the example illustrated in FIG. 8, the stepping motor 103 can be rotated by using the forward-rotation driving pulse having the pulse length with which the stepping motor 103 makes a predetermined forward rotation, similarly as in the example illustrated in FIG. 5. As a result, high-speed reverse rotation of the stepping motor 103 and reduction in power consumption can be realized.

FIG. 9 is a time chart for explaining an example in which the process illustrated in FIG. 8 is executed by the timepiece 1 of the second embodiment.

In the example illustrated in FIG. 9, at time t21, the step S31A in FIG. 8 is executed, and the motor drive circuit 109 applies the first forward-rotation driving pulse PF1a to the stepping motor 103.

Next, at or after (specifically, the period from time t21A to time t22) a first determination period elapsed time point t21A at which the determination period Tcomp elapses from the application time t21 of the first forward-rotation driving pulse PF1a, since the steps S31B and S31C in FIG. 8 are executed and the induced voltage VRs has not become larger than the reference threshold voltage Vcomp, it is determined that the stepping motor 103 has not made a predetermined forward rotation by the application of the first forward-rotation driving pulse PF1a.

Next, at time t22, the step S32A in FIG. 8 is executed, and the motor drive circuit 109 applies the second forward-rotation driving pulse PF1b to the stepping motor 103.

Next, at or after (specifically, the period from time t22A to time t23) a second determination period elapsed time point t22A at which the determination period Tcomp elapses from the application time t22 of the second forward-rotation driving pulse PF1b, since the steps S32B and S32C in FIG. 8 are executed and the induced voltage VRs has not become larger than the reference threshold voltage Vcomp, it is determined that the stepping motor 103 has not made a predetermined forward rotation by the application of the second forward-rotation driving pulse PF1b.

Next, at time t23, the step S33A in FIG. 8 is executed, and the motor drive circuit 109 applies the third forward-rotation driving pulse PF1c to the stepping motor 103.

Next, at or after (specifically, the time point t23A) a third determination period elapsed time point t23A at which the determination period Tcomp elapses from the application time t23 of the third forward-rotation driving pulse PF1c, since the steps S33B and S33C in FIG. 8 are executed and the induced voltage VRs becomes larger than the reference threshold voltage Vcomp, it is determined that the stepping motor 103 has made a predetermined forward rotation by the application of the third forward-rotation driving pulse PF1c.

Next, at time t24, the step S33D in FIG. 8 is executed and the motor drive circuit 109 applies the third forward-rotation driving pulse PF1c to the stepping motor 103 as the driving pulse (repulsion pulse) P1 (see FIG. 3B).

Next, at or after time t25, the step S40 in FIG. 8 is executed, and the reverse driving pulse whose pulse length is determined based on the pulse length of the third forward-rotation driving pulse PF1c is applied to the stepping motor 103 as the driving pulses (suction pulses) P2 and P3 by the motor drive circuit 109. As a result, the stepping motor 103 is rotated in the reverse direction.

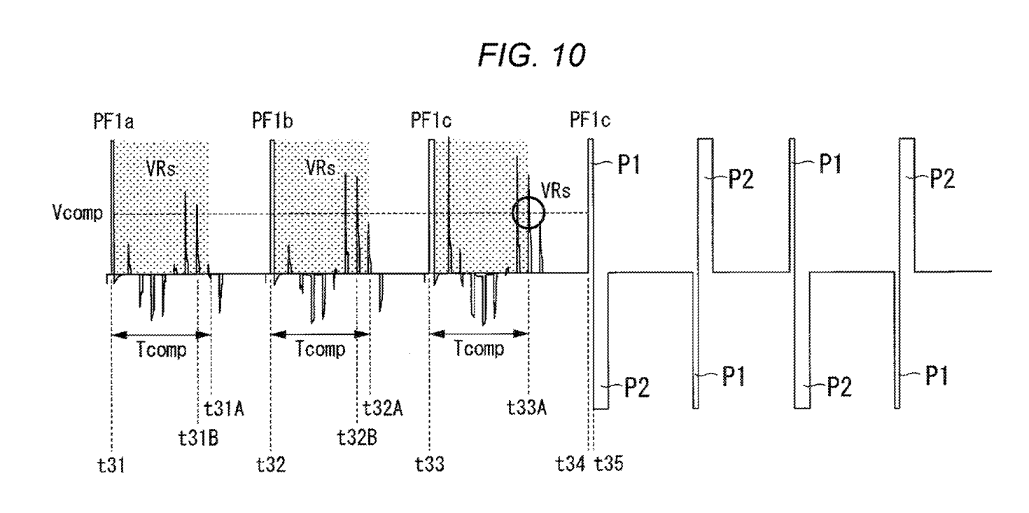

FIG. 10 is a time chart for explaining another example in which the process illustrated in FIG. 8 is executed by the timepiece 1 of the second embodiment.

In the example illustrated in FIG. 10, at time t31, the step S31A in FIG. 8 is executed, and the motor drive circuit 109 applies the first forward-rotation driving pulse PF1a to the stepping motor 103.

Next, at or after (specifically, the period from time t31A to time t32) a first determination period elapsed time point t31A at which the determination period Tcomp elapses from the application time t31 of the first forward-rotation driving pulse PF1a, since the steps S31B and S31C in FIG. 8 are executed and the induced voltage VRs has not become larger than the reference threshold voltage Vcomp, it is determined that the stepping motor 103 has not made a predetermined forward rotation by the application of the first forward-rotation driving pulse PF1a.

Next, at time t32, the step S32A in FIG. 8 is executed, and the motor drive circuit 109 applies the second forward-rotation driving pulse PF1b to the stepping motor 103.

Next, at or after (specifically, the period from time t32A to time t33) a second determination period elapsed time point t32A at which the determination period Tcomp elapses from the application time t32 of the second forward-rotation driving pulse PF1b, since the steps S32B and S32C in FIG. 8 are executed and the induced voltage VRs has not become larger than the reference threshold voltage Vcomp, it is determined that the stepping motor 103 has not made a predetermined forward rotation by the application of the second forward-rotation driving pulse PF1b.

Next, at time t33, the step S33A in FIG. 8 is executed, and the motor drive circuit 109 applies the third forward-rotation driving pulse PF1c to the stepping motor 103.

Next, at or after (specifically, the time point t33A) a third determination period elapsed time point t33A at which the determination period Tcomp elapses from the application time t33 of the third forward-rotation driving pulse PF1c, since the steps S33B and S33C in FIG. 8 are executed and the induced voltage VRs becomes larger than the reference threshold voltage Vcomp, it is determined that the stepping motor 103 has made a predetermined forward rotation by the application of the third forward-rotation driving pulse PF1c.

Next, at time t34, the step S33D in FIG. 8 is executed and the motor drive circuit 109 applies the third forward-rotation driving pulse PF1c to the stepping motor 103 as the driving pulse (repulsion pulse) P1 (see FIG. 3B).

Next, at or after time t35, the step S40 in FIG. 8 is executed, and the reverse driving pulse whose pulse length is determined based on the pulse length of the third forward-rotation driving pulse PF1c is applied to the stepping motor 103 as the driving pulse (suction pulses) P2 by the motor drive circuit 109. As a result, the stepping motor 103 is rotated in the reverse direction.

The difference between the example illustrated in FIG. 9 and the example illustrated in FIG. 10 is the presence or absence of the driving pulse P3. In the invention, the driving pulse P3 is unnecessary, and the reverse rotation by only the driving pulses P1 and P2 can also be made. With this configuration, the pulse length necessary for the reverse rotation can be shortened, so that it is possible to further increase the drive frequency of reverse rotation.

As described above, in the timepiece 1 of the second embodiment, in a case where the required time from the application points in time t21 and t31 of the first forward-rotation driving pulse PF1a to the points in time t21B and t31B at which the induced voltage VRs larger than the reference threshold voltage Vcomp is generated is shorter than the determination period Tcomp, it is determined that the stepping motor 103 has not made a predetermined forward rotation.

In a case where the required time from the application points in time t22 and t32 of the second forward-rotation driving pulse PF1b to the points in time t22B and t32B at which the induced voltage VRs larger than the reference threshold voltage Vcomp is generated is shorter than the determination period Tcomp, it is determined that the stepping motor 103 does not make a predetermined forward rotation.

On the other hand, in a case where the required time from the application points in time t23 and t33 of the third forward-rotation driving pulse PF1c to the points in time t23A and t33A at which the induced voltage VRs larger than the reference threshold voltage Vcomp is generated is equal to or longer than the determination period Tcomp, it is determined that the stepping motor 103 has made a predetermined forward rotation.

### Modification Example

The pulse energy of the first forward-rotation driving pulse PF1a in the reverse rotation preparation process may be energy determined by the control circuit 106 based on the pulse energy applied to the stepping motor 103 at the timing just before the start of execution of the reverse rotation preparation process.

In the timepiece 1 configured as described above, the pulse energy of the first forward-rotation driving pulse PF1a can be applied to the stepping motor 103 with energy larger than a predetermined energy. Therefore, it is possible to shorten the period from the start of execution of the reverse rotation preparation process until it is determined that the induced voltage VRs is larger than the reference threshold voltage Vcomp.

In the reverse rotation preparation process, it is not always necessary that all the test pulses applied to the stepping motor 103 have the same polarity before determining the driving pulse P1. The polarity of at least one test pulse among the test pulses may be different from the polarity of the other test pulse. Specifically, before the driving pulse P1 is determined in the reverse rotation preparation process, a process of applying a test pulse of first polarity and the process of applying a test pulse of second polarity different from the first polarity may be executed. In a case where the first polarity is, for example, positive polarity, the second polarity is negative polarity. In a case where the first polarity is, for example, negative polarity, the second polarity is positive polarity.

In the timepiece 1 configured as described above, the driving pulse P1 is determined by applying the test pulses of positive and negative polarity to the stepping motor 103. Therefore, it is possible to suppress the amount of excess or deficiency of energy required for the rotation of the stepping motor 103 due to magnetic disturbance such as influence of the magnetic field and polarization of the magnet.

It is desirable that the time from the application of the test pulse to the application of the next test pulse is 15 ms or more. If the time from the application of the test pulse to the application of the next test pulse is 15 ms or more, since the rotation of the rotor 202 is stopped from the application of the test pulse to the application of the next test pulse, deterioration in accuracy of energy determination by the test pulse is suppressed.

In a case where it is not determined that the induced voltage VRs is larger than the reference threshold voltage Vcomp even if the pulse energy of the test pulse is equal to or greater than a predetermined value, the motor drive circuit 109 may apply the driving pulse P1, the driving pulse P2, and the driving pulse P3 whose energy is predetermined pulse energy and whose polarity is the same as that of the first pulse to the stepping motor 103. The predetermined pulse energy may be, for example, pulse energy to the extent that predetermined reverse rotation does not occur.

In the timepiece 1 configured as described above, the hand of the timepiece 1 can be driven in the reverse direction even in a case where detection failure of the induced voltage by the forward-rotation drive rotation detection circuit 110 occurs.

In a case where the pulse length is determined to be within a predetermined range by the control circuit 106, the rotor 202 may be driven by the driving pulse P1 and the driving pulse P2, and in a case where the pulse length is determined to be outside the predetermined range by the control circuit 106, the rotor 202 may be driven by the driving pulse P1, the driving pulse P2, and the driving pulse P3.

The first forward-rotation driving pulse PF1a is an example of a first test pulse of the plurality of test pulses that are consecutively output. The driving pulse P3 is an example of a third pulse.

A program for realizing all or some of the functions of the timepiece 1 of the invention may be recorded on a computer-readable recording medium and the program recorded on the computer-readable recording medium may be read into a computer system and executed by the computer system, so that processing of each unit may be performed. The “computer system” referred to here includes hardware such as an OS and peripheral devices. Also, the “computer system” includes a homepage providing environment (or display environment) as long as it is using a WWW system.

The “computer-readable recording medium” means a storage device such as a portable medium such as a flexible disk, a magneto-optical disk, a ROM, and a CD-ROM, and a hard disk built in a computer system. Furthermore, the “computer-readable recording medium” includes those (a recording medium) holding a program dynamically for a short time, such as a communication line in a case of transmitting a program via a network such as the Internet or a communication line such as a telephone line and those (a recording medium) holding the program for a certain period of time, such as volatile memory inside a computer system serving as a server or client in that case. The program described above may be for realizing some of the functions described above, and may be realized by combining the functions described above with a program already recorded in the computer system.

Although the embodiments of the stepping motor control device, the timepiece, and the stepping motor control method of the invention have been described in detail with reference to the drawings, the specific configurations thereof are not limited to the embodiments, and design changes and the like within the scope not deviating from the gist of the invention are included.

What is claimed is:

1. A stepping motor control device comprising:
a rotation detection unit that detects a rotation state of a rotor of the stepping motor after outputting a driving pulse to the stepping motor that rotates a hand;
a control unit that controls the hand to be driven to rotate in a reverse direction by at least a first pulse and a second pulse having polarity different from that of the first pulse as the driving pulse and controls the hand to be driven to rotate in the reverse direction by outputting a plurality of first pulses having different energies as a plurality of test pulses before outputting the first pulse, causing the rotation detection unit to detect the rotation state of the rotor by the test pulse after outputting each of the plurality of test pulses, setting a test pulse according to the detected rotation state as the first pulse, and using at least the set first pulse and the second pulse.

2. The stepping motor control device according to claim 1,
wherein the plurality of test pulses are consecutively output in the order from a pulse having small energy to a pulse having large energy, and
the control unit sets a test pulse having a predetermined energy less than energy necessary for forward rotation of the hand and corresponding to energy of a rotation pulse immediately before the rotor reaches a predetermined rotation angle as the first pulse.

3. The stepping motor control device according to claim 2,
wherein, in a case where an induced voltage generated with application of the test pulse is larger than a reference threshold voltage, the control unit determines that the rotor has the predetermined amount of energy and sets the test pulse as the first pulse.

4. The stepping motor control device according to claim 2,
wherein, in a case where a required time from an application time point of the test pulse to a time point at which the induced voltage larger than the reference threshold voltage is generated is equal to or longer than a determination period, the control unit determines that the rotor has the predetermined amount of energy and sets the test pulse as the first pulse.

5. The stepping motor control device according to claim 1, further comprising:
a stator capable of forming a magnetic path between the rotor and the stator and a drive coil capable of forming a magnetic path in the stator,
wherein the control unit outputs the plurality of test pulses so that all of the plurality of test pulses are generated by one polarity of the magnetic path.

6. A timepiece comprising:
the stepping motor control device according to claim 1; and
the hand.

7. A control method of a stepping motor for a timepiece comprising:
a step of outputting a plurality of first pulses having different energies as a plurality of test pulses before outputting a first pulse as a driving pulse to a stepping motor that rotates a hand,
a step of detecting the rotation state of the rotor by the test pulse after outputting each of the plurality of test pulses,
a step of setting a test pulse according to the detected rotation state as the first pulse, and
a step of driving the hand in a reverse direction by using at least the set first pulse and the second pulse different in polarity from the first pulse.

8. A control method of a stepping motor for a timepiece comprising:
at the time of a reverse rotation start of the stepping motor,
applying a first forward-rotation driving pulse having a pulse length to the extent that the stepping motor does not make a predetermined forward rotation to the stepping motor and determining whether or not the stepping motor has made the predetermined forward rotation by application of the first forward-rotation driving pulse;
applying a second forward-rotation driving pulse obtained by adding pulse energy to the first forward-rotation driving pulse to the stepping motor and determining whether or not the stepping motor has made the predetermined forward rotation by application of the second forward-rotation driving pulse in a case where it is determined that the stepping motor has not made the predetermined forward rotation by the application of the first forward-rotation driving pulse;
determining a pulse length of a reverse-rotation driving pulse based on a pulse length of the second forward-rotation driving pulse in a case where it is determined that the stepping motor has made the predetermined forward rotation by the application of the second forward-rotation driving pulse; and
repeating addition of the pulse energy and a determination as to whether or not the stepping motor has made the predetermined forward rotation by application of the forward-rotation driving pulse after the addition until the stepping motor makes the predetermined forward rotation.

9. The control method of the stepping motor for the timepiece according to claim 8,
wherein the application of the forward-rotation driving pulse is repeated until the stepping motor makes the predetermined forward rotation, and application of a reverse-rotation driving pulse is not performed until the stepping motor makes the predetermined forward rotation.

10. The control method of the stepping motor for the timepiece according to claim 8,
wherein, in a case where an induced voltage generated with the application of the first forward-rotation driving pulse is larger than a reference threshold voltage, it is determined that the stepping motor has made the predetermined forward rotation.

11. The control method of the stepping motor for the timepiece according to claim 8,
wherein, in a case where the required time from an application time point of the first forward-rotation driving pulse to a time point at which the induced voltage larger than the reference threshold voltage is generated is equal to or longer than a determination period, it is determined that the stepping motor has made the predetermined forward rotation.

12. The stepping motor control device according to claim 1,
wherein energy of a first test pulse of the plurality of test pulses that are consecutively output is determined based on energy of a driving pulse output to the stepping motor at the timing just before the first test pulse is output.

13. The stepping motor control device according to claim 1,
wherein polarity of at least one test pulse among the plurality of test pulses that are consecutively output is different from polarity of other test pulses.

14. The stepping motor control device according to claim 1,
wherein the time from application of the test pulse to application of the next test pulse is 15 ms or more.

15. The stepping motor control device according to claim 1,
wherein, in a case where the energy of the test pulse is equal to or greater than a predetermined value and the induced voltage generated with the application of the test pulse is not larger than the reference threshold voltage, the first pulse, the second pulse, and a third pulse having predetermined energy and having the same polarity as that of the first pulse are applied to the stepping motor.

16. The stepping motor control device according to claim 1,
wherein, in a case where a pulse length of the first pulse which is set by the control unit is a length within a predetermined range, the stepping motor is driven by the first pulse and the second pulse, and in a case where the pulse length of the first pulse which is set by the control unit is a length outside the predetermined range, the stepping motor is driven by the first pulse, the second pulse, and a third pulse having predetermined energy and having the same polarity as that of the first pulse.
